(19) United States
(12) Patent Application Publication
(10) Pub. No.: US 2015/0041713 A1
(43) Pub. Date: Feb. 12, 2015

(54) INTERMETALLIC COMPOUNDS FOR RELEASING MERCURY

(71) Applicants: Steven C. Hansen, Urbana, IL (US); Tryggvi I. Emilsson, Champaign, IL (US); Daniel J. Gordon, Savoy, IL (US)

(72) Inventors: Steven C. Hansen, Urbana, IL (US); Tryggvi I. Emilsson, Champaign, IL (US); Daniel J. Gordon, Savoy, IL (US)

(73) Assignee: Advanced Lighting Technologies, Inc., Solon, OH (US)

(21) Appl. No.: 14/453,404

(22) Filed: Aug. 6, 2014

Related U.S. Application Data
(60) Provisional application No. 61/862,680, filed on Aug. 6, 2013.

(51) Int. Cl. C09K 11/02; C23C 30/00; C23C 24/04; H01J 61/26; C09K 11/89

(52) U.S. Cl. CPC C09K 11/025; H01J 61/26; C09K 11/89; C23C 24/04; C23C 30/00
USPC 252/301.6 R; 252/301.4 R; 427/180

(57) ABSTRACT

Materials, compounds, systems, and methods of dosing fluorescent lamps to reduce run-up time by improving mercury release rates. A pellet comprises a core and a coating on at least a portion of the surface of the core, the coating being formed from a powder of one or more intermetallic compounds comprising mercury. A method comprises providing a core and forming a coating on at least a portion of the surface of the core with a material comprising one or more intermetallic compounds comprising mercury and a metal selected from the group consisting of silver, copper, tin, zinc, bismuth, gold, platinum, palladium, nickel, manganese, and titanium.

### FIELD OF THE INVENTION

The present disclosure generally relates to solid materials for releasing mercury at desired temperatures. One suitable application includes dose materials for fluorescent lamps. More specifically, as applied to dose materials for fluorescent lamps, the present disclosure is directed to materials, compounds, systems, and methods of dosing fluorescent lamps to reduce run-up time.

### BACKGROUND

In many applications it is desirable to provide a solid material at room temperature containing mercury which releases a desired amount of mercury at elevated temperature. One suitable application includes the solid dose materials for dosing amounts of mercury in fluorescent lamps.

Fluorescent lamps include, but are not limited to, linear lamps of tubular construction (i.e. T3, T5, T8, T12), compact fluorescent lamps (CFLs) of U-tube and spiral construction, cold cathode fluorescent lamps, vacuum fluorescent display devices, electrodeless fluorescent lamps and fluorescent lamps with conventional tungsten filament cathodes. Fluorescent lamps may be classified as either non-regulating or “temperature-controlled,” in which the cold spot temperature of the lamp determines the mercury vapor pressure, or as regulating or “amalgam-controlled,” in which the mercury vapor pressure is regulated by an amalgam of a chemical composition designed to provide the proper vapor pressure in a lamp that operates at higher temperatures.

Zn—Hg and Sn—Hg amalgams are useful dose materials in fluorescent lamps, most often in temperature-controlled lamps. They provide the vapor phase mercury required for the low pressure discharge operation, typically with a vapor pressure nearly equal to that of pure liquid mercury.

Certain fluorescent lamp designs, notably low-wattage CFLs, suffer from the phenomenon of slow run-up time. Run-up time is the time required for a fluorescent lamp to achieve a certain percentage (typically 80%) of full lumens output from a cold start. Slow run-up can be particularly problematic when the lamps have been stored for a month or more.

One proposed explanation for slow run-up behavior in fluorescent lamps is the “re-absorption” of mercury vapor by amalgam doses such as Zn—Hg during lamp storage. A second possible reason for the slower run-up behavior of Zn—Hg may be by the oxidation of the zinc amalgam. Oxidation may be caused by outgassing of the components inside the lamp after it is manufactured.

### SUMMARY

It is thus an object of the present disclosure to present an apparatus, systems, and methods to overcome the deficiencies in the prior art discussed above. In some embodiments, a pellet comprises a core and a coating on at least a portion of the surface of the core, the coating being formed from a powder of one or more intermetallic compounds comprising mercury. In other embodiments, a pellet comprises a core and a coating on at least a portion of the surface of the core, the coating comprising one or more intermetallic compounds of mercury and a metal selected from the group consisting of silver, copper, tin, zinc, gold, platinum, palladium, nickel, manganese, and titanium. In further embodiments, a pellet comprises a core and a coating on at least a portion of the surface of the core, the coating being formed from a material comprising at least five weight percent mercury. In still further embodiments, a pellet comprises a core; and a coating encapsulating the core, the coating comprising one or more intermetallic compounds of mercury and a metal selected from the group consisting of silver, copper, tin, zinc, gold, platinum, palladium, nickel, manganese, and titanium.

In some embodiments, a method comprises providing a core and forming a coating on at least a portion of the surface of the core with a material comprising one or more intermetallic compounds comprising mercury and a metal selected from the group consisting of silver, copper, tin, zinc, gold, platinum, palladium, nickel, manganese, and titanium. In other embodiments, a method comprises providing a core and encapsulating the core in a coating comprising one or more intermetallic compounds comprising mercury and a metal selected from the group consisting of silver, copper, tin, zinc, gold, platinum, palladium, nickel, manganese, and titanium.

The foregoing and additional aspects and embodiments of the present invention will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the invention will become apparent upon reading the following detailed description and upon reference to the drawings.

FIG. 1A is a cutaway view schematic diagram of a Zn—Hg pellet produced in a drop tower.

FIG. 1B is a cutaway view schematic diagram of a Zn—Hg pellet produced by mechanical plating.

FIG. 2A is a cutaway view schematic diagram of a Zn—Hg pellet produced in a drop tower with intermetallic coating in accordance with some embodiments of the present disclosure.

FIG. 2B is a cutaway view schematic diagram of a Zn—Hg pellet produced by mechanical plating with intermetallic coating in accordance with some embodiments of the present disclosure.

FIG. 3A is a graph comparing the mercury release rate of a non-coated Zn—Hg pellet and a Zn—Hg pellet with an intermetallic coating in accordance with some embodiments of the present disclosure.

FIG. 3B is a graph comparing the mercury release rate of a non-coated Zn—Hg pellet and a Zn—Hg pellet with an intermetallic coating in accordance with some embodiments of the present disclosure.

FIG. 4 is a graph of a diffraction pattern from a silver mercury amalgam in accordance with some embodiments of the present disclosure.

FIG. 5 is a schematic diagram of a fluorescent lamp with a Zn—Hg pellet with an intermetallic coating in accordance with some embodiments of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

In one suitable application, the present disclosure is directed to materials, systems, and methods to improve the rate of mercury release during lamp run-up as the lamp warms up from ambient temperature to its final operating temperature, thus providing a rapid increase in lumens once the lamp is turned on and reducing the so-called run-up time. Such materials include an intermetallic coating compound comprising mercury or having a high mercury content. In some instances, a high mercury content is mercury content greater than 50 weight percent. The coating may be formed from a powder. Such materials additionally include a core comprising an amalgam. In some embodiments of the present disclosure, increased mercury release rates are achieved using an intermetallic compound of silver and mercury applied to a zinc mercury amalgam.

Although re-absorption of mercury vapor by amalgam doses may be a contributing factor to slow run-up, the rate at which the desired (equilibrium) mercury vapor is attained is limited by the rate of mercury release from the amalgam particle surface during lamp warm-up. Measurements of mercury release rates on a variety of fluorescent lamp amalgam materials indicate that the amalgam surface can react with traces of oxygen or water vapor to become covered by a thin film of metal oxide or hydroxide. These films reduce the evaporation rate of mercury vapor. In the case of Zn—Hg amalgams, the surface gets covered by a thin layer (i.e. a few nanometers) of ZnO or Zn(OH)₂. Since even the highest-quality lamps are not totally free of oxygen or water vapor, a thin oxide/hydroxide film may form on the amalgam pellet inside nearly any fluorescent lamp upon storage, leading to a lower rate of mercury release and to slow lamp run-up.

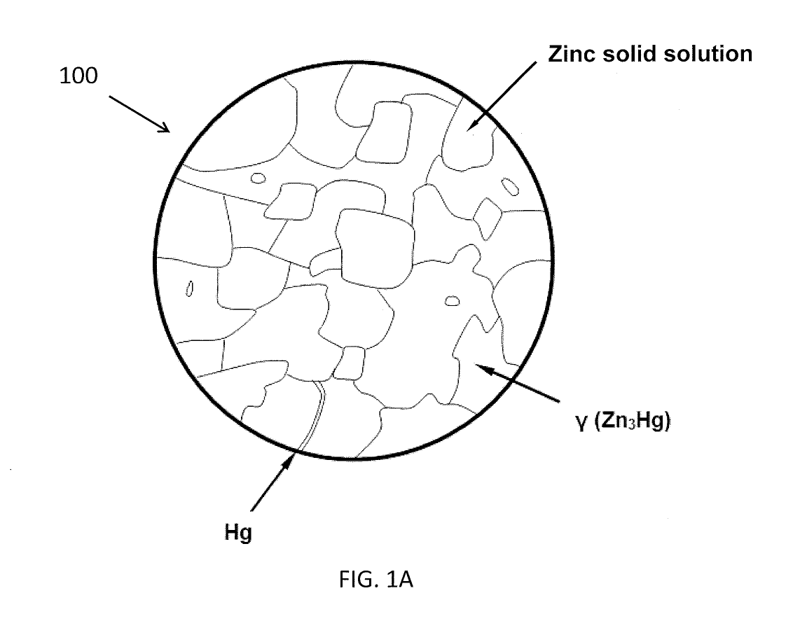

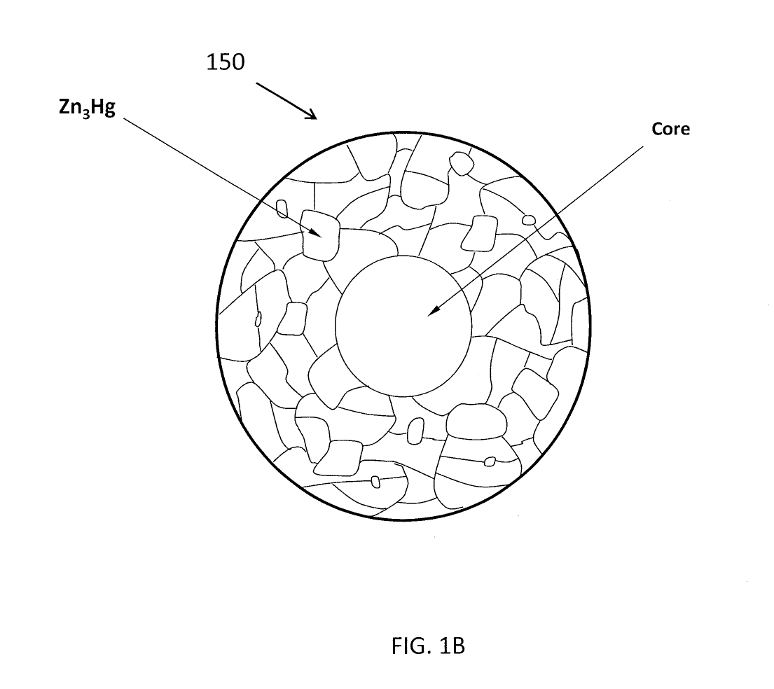

FIG. 1A is a cutaway view schematic diagram of a Zn—Hg pellet 100 produced by rapid quenching of a molten material from a drop tower in accordance with the methods disclosed in in “Chemical composition and crystal structure of the γ₁-phase in the silver-mercury system,” P. Andersen and S. J. Jensen, Scand. J. Dent. Res., 79, 466-471 (1971). The illustrated Zn—Hg pellet 100 comprises a plurality of γ (Zn₃Hg) crystals, zinc solid solution, and thin Hg crystals interspersed therein.

Zn—Hg pellets similar to that illustrated in FIG. 1A and produced in a drop tower are also described in U.S. Pat. Nos. 5,882,237; 6,339,287; and 6,791,254. These patents describe a zinc mercury amalgam useful in fluorescent lamp manufacture. The disclosed amalgams are composed of a zinc-rich outer shell and a mercury-rich center. The microstructure is present in a metastable, non-equilibrium state.

The Zn—Hg pellet 100 illustrated in FIG. 1A suffers from the problems described above, namely re-absorption and oxidation leading to slow run-up in fluorescent lamps.

FIG. 1B is a cutaway view schematic diagram of a Zn—Hg pellet 150 produced by mechanical plating, as described for example in U.S. Patent Application Publication No. 2011/0250455 to Gordon et al. This publication is directed to the manufacture and use of mechanically plated zinc mercury amalgams, which have a different microstructure than the drop tower Zn—Hg pellet 100 described above with reference to FIG. 1A. Mechanically plated Zn—Hg pellet 150 typically comprises almost entirely γ (Zn₃Hg) phase and mercury-rich liquid phase. Mechanically plated Zn—Hg pellet 150 often suffers from the same mercury release problems as drop tower Zn—Hg pellet 100, such as re-absorption and oxidation.

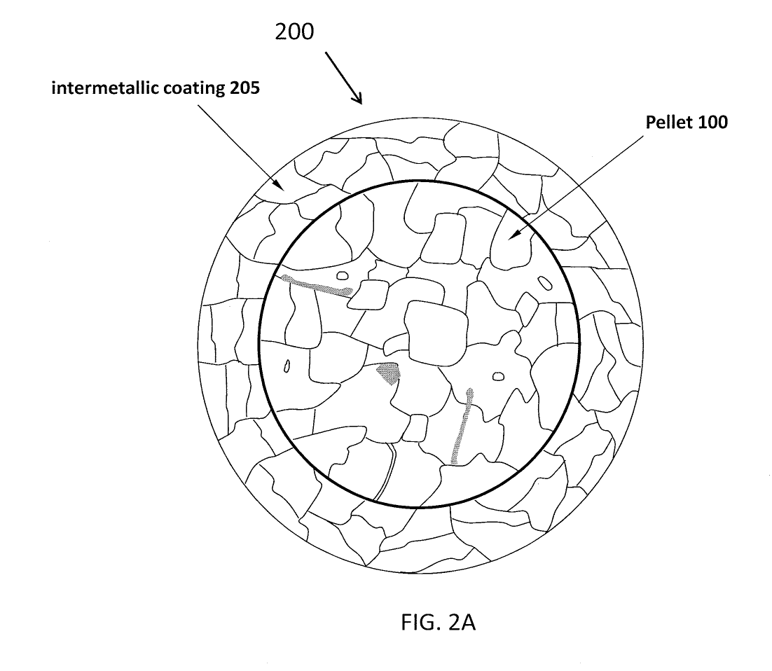

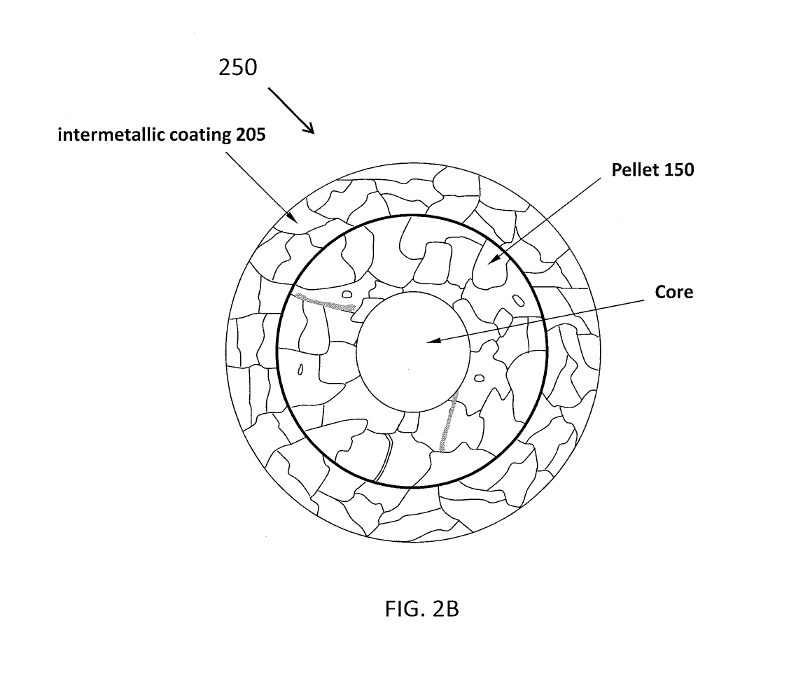

FIG. 2A is a cutaway view schematic diagram of a Zn—Hg pellet 200 produced in a drop tower with intermetallic coating 205 in accordance with some embodiments of the present disclosure. Noble metal intermetallic compounds such as Ag₂Hg₃, CuxₓHg_{y} (e.g., Cu₇Hg₆), and NiₓHg_{y} exhibit high mercury release properties. These materials may be applied as a coating 205 to amalgam pellets, such as those described above with reference to FIGS. 1A and 1B, to enhance the mercury release rate and provide rapid lamp run-up. In other embodiments, amalgam pellet coatings are formed from copper-mercury amalgam compounds, nickel-mercury amalgam compounds, gold-mercury amalgam compounds, platinum and palladium amalgam compounds and other transition and noble metal compounds.

In some embodiments, Zn—Hg pellet 200 comprises a core and an intermetallic coating 205 is coated on at least a portion of that core. In other embodiments, intermetallic coating 205 encapsulates the core of Zn—Hg pellet 200. In some embodiments, the core of Zn—Hg pellet 200 is Zn—Hg pellet 100.

In some embodiments, the intermetallic compound used to form the coating on the amalgam pellet is produced in the form of finely divided powder. Powder sizes may range from a large size of 200 μm to a small size of less than 0.01 μm. The powder may be composed of nanocrystalline metal, mercury and nanocrystalline intermetallic metal-mercury compounds or all three at the same time. Small particle size is helpful in enhancing mercury release. Mercury may be trapped within the very fine particles and greatly increase the surface area of mercury-rich amalgam. The increase in the dispersion of the mercury assists in the high rate of release of mercury vapor from the interior amalgam. Thus, in some embodiments the powder comprises liquid mercury, a saturated amalgam in the form of a liquid silver amalgam, pure silver, a silver-mercury solid solution, a β-AgHg intermetallic compound, an α-AgHg solid solution, or any other form of mercury and any other form of silver within the silver mercury binary system alone or in any combination thereof. Further, in some embodiments the powder additionally includes one or more metals from the group consisting of copper, tin, zinc, gold, platinum, palladium, nickel, manganese, and titanium.

In some embodiments, the powder comprises a copper and mercury compound such as Cu₇Hg₆. In some embodiments the powder comprises liquid mercury, a saturated amalgam in the form of a liquid copper amalgam, pure copper, a copper-mercury solid solution, a β-Cu(Hg) intermetallic compound, an α-Cu(Hg) solid solution, or any other form of mercury and any other form of copper within the copper mercury binary system alone or in any combination thereof. Further, in some embodiments the powder additionally includes one or more metals from the group consisting of silver, tin, zinc, gold, platinum, palladium, nickel, manganese, and titanium.

In some embodiments, the powder comprises a nickel and mercury compound such as NiHg₄ or other nickel mercury intermetallic compounds, alone or in any combination thereof. In some embodiments, the powder comprises a platinum and mercury compound such as PtHg₂ or PtHg₄. In some embodiments, the powder comprises a palladium and mercury compound. In some embodiments, the powder comprises a gold and mercury compound.

In some embodiments, a ternary intermetallic compounds is formed and is used alone or is mixed together to form an admixture of intermetallic metal compounds. The resulting admixture is then used to form the coating 205 on an amalgam pellet. In some embodiments, the binary intermetallic compounds comprise mercury and a metal selected from the group consisting of silver, copper, tin, zinc, gold, platinum, palladium, nickel, manganese, and titanium.

In some embodiments, the coating 205 is formed by rolling the intermetallic compound powder onto a pellet. In other embodiments, coating 205 is formed by mechanically plating intermetallic compound powder onto a pellet. In some embodiments, the intermetallic compound powder is present in amounts ranging from 0.1 weight percent of the total weight of the pellets to 20 weight percent of the total mass of the pellets. In other embodiments, an even higher weight percent of intermetallic compound is desired.

In some embodiments, intermetallic compounds further provide the coated amalgam pellets or particles with a non-stick coating which prevents cohesion (i.e. sticking or clumping) of the pellets or particles. The prevention of cohesion is helpful in the handling and dosing of the pellets or particles in the lamp manufacturing process

Although the coatings described above are disposed on a pellet, such that the pellet serves as a substrate, in other embodiments the substrate may be comprised of any type of amalgam for use in lamps that are either non-regulating (temperature-controlled) or regulating (amalgam-controlled). Substrates may also be composed of solid particles or surfaces of any metallic or non-metallic composition.

FIG. 2B is a cutaway view schematic diagram of a Zn—Hg pellet 250 produced by mechanical plating with intermetallic coating 205 in accordance with some embodiments of the present disclosure. The Zn—Hg pellet 250 is that described above with reference to FIG. 1B, while the intermetallic coating 205 is that described above with reference to FIG. 2A.

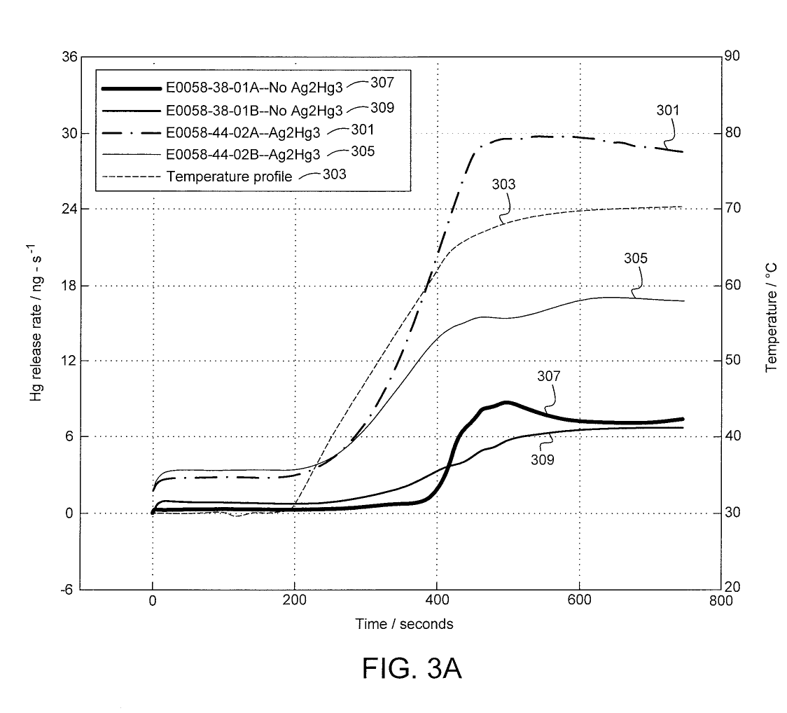

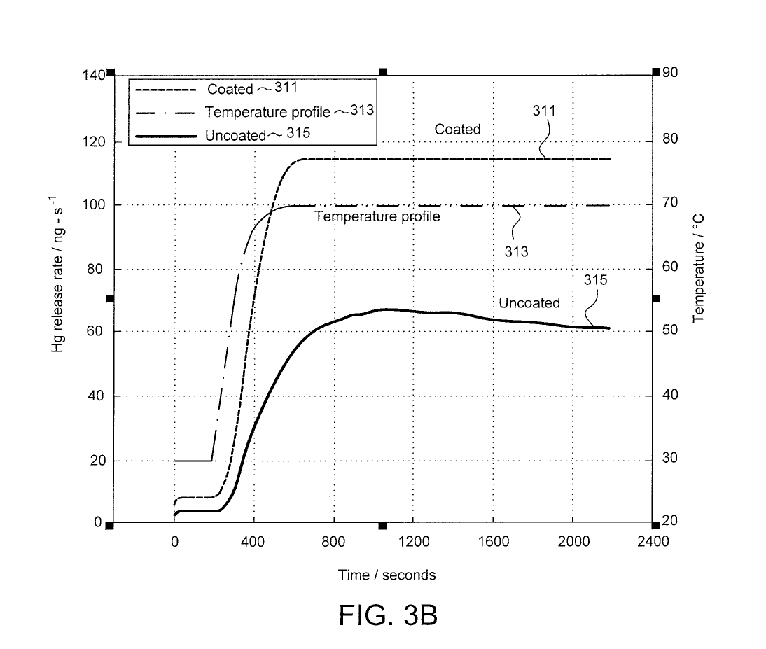

FIG. 3A is a graph comparing the mercury release rate of a non-coated Zn—Hg pellet 100 produced by drop tower and a Zn—Hg pellet 200 with an intermetallic coating 205 in accordance with some embodiments of the present disclosure. FIG. 3B is a graph comparing the mercury release rate of a non-coated Zn—Hg pellet 150 produced by mechanical plating and a Zn—Hg pellet 250 with an intermetallic coating 205 in accordance with some embodiments of the present disclosure. In both FIG. 3A and FIG. 3B, the pellets 200, 250 with intermetallic coatings 205 demonstrate higher mercury release rates than the pellets 100, 150 lacking intermetallic coatings 205. The higher mercury release rates result in lower run-up times as fluorescent lamps having higher mercury release rates more quickly achieve the desired (equilibrium) mercury vapor.

In FIG. 3A, a temperature profile 303 is provided over time as temperature rises from approximately 0° C. to approximately 70° C. A first non-coated mercury release rate profile 307 and second non-coated mercury release rate profile 309 illustrate significantly lower mercury release rates than a first coated mercury release rate profile 301 and second coated mercury release rate profile 303.

Similarly, in FIG. 3B, a temperature profile 313 is provided over time as temperature rises from approximately 20° C. to approximately 70° C. A first non-coated mercury release rate profile 315 illustrates significantly lower mercury release rates than a first coated mercury release rate profile 311.

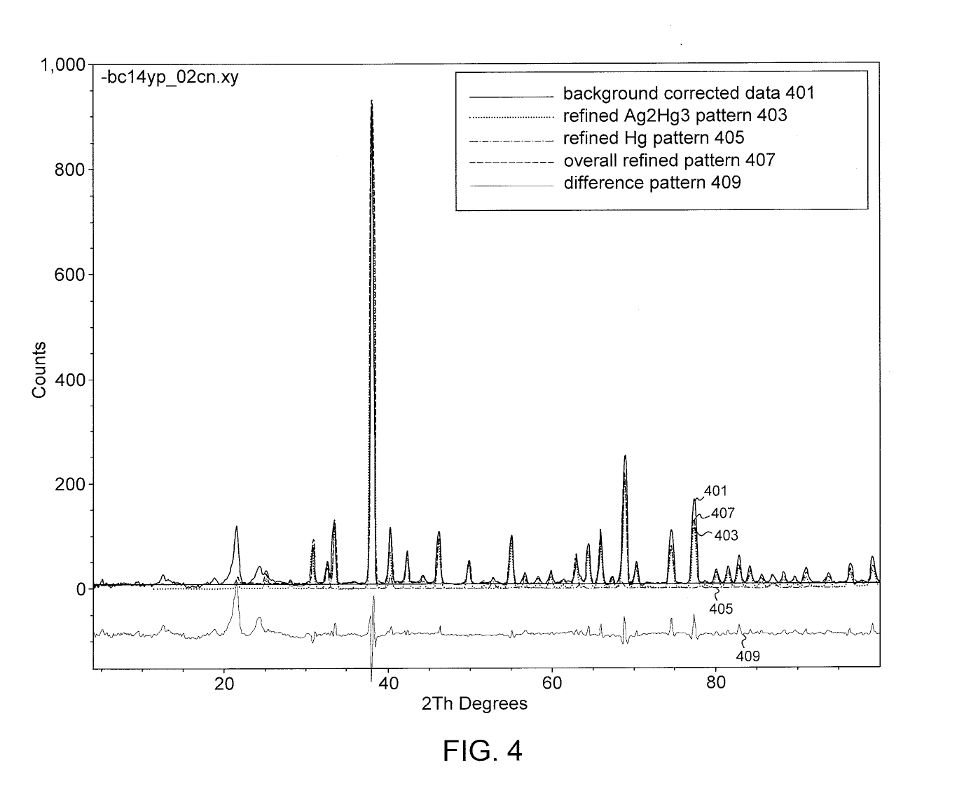

FIG. 4 is a graph of a diffraction pattern from a silver mercury amalgam at −70° C. in accordance with some embodiments of the present disclosure. FIG. 4 illustrates profiles for background corrected data 401, refined Ag₂Hg₃ pattern 403, refined Hg pattern 405, overall refined pattern 407, and difference pattern 409.

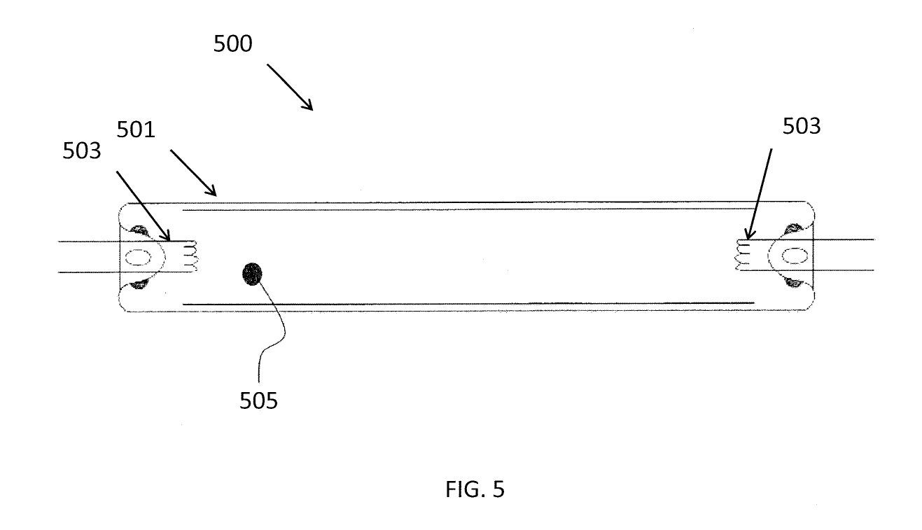

FIG. 5 is a schematic diagram of a fluorescent lamp 500 with a Zn—Hg pellet 505 with an intermetallic coating in accordance with some embodiments of the present disclosure. Fluorescent lamp 500 comprises a tube 501 having an electrode 503 disposed at opposing ends of the tube 501. Electrodes 503 are often also referred to in the art as cathodes. A pellet 505 having an intermetallic coating is disposed within tube 501.

The present disclosure additionally provides methods of forming intermetallic coatings, which are provided below as two non-limiting examples of formation processes. The intermetallic compounds containing mercury may be formed by known prior art methods for the synthesis of such compounds.

### EXAMPLE 1

Ag₂Hg₃ powder was prepared by co-reduction of an aqueous solution containing Hg(II) and Ag(I). The synthesized Ag₂Hg₃ powder was subjected to x-ray diffraction analysis. X-ray diffraction identified two phases: Ag₂Hg₃ with a small fraction of mercury as shown in FIG. 4.

Pellets 100, 150 as shown in FIGs. 1A and 1B and as described above were each coated by mechanical mixing (plating) with Ag₂Hg₃ powder at a loading of ca. 1 wt % of the total pellet 100, 150 mass. The resulting pellets 200, 250 with intermetallic coatings 205 are shown schematically in FIGS. 2A and 2B.

Samples of coated pelletes 200, 250 were then subjected to a mercury vapor release rate test in which high-purity argon gas was passed over a single pellet 200, 250 of each material at a flow rate of 5,000 mL/min. The sample temperature was ramped from 30° C. to 70° C. at a rate of 10° C./min, and the mercury concentration in the argon stream was measured by atomic absorption spectrophotometry. The mercury release rates as a function of temperature are computed from the measured mercury concentration and the argon flow rate and are shown as FIGS. 3A and 3B. In both cases the pellets 200, 250 coated with the Ag₂Hg₃ powder showed significantly higher mercury release rates when compared to the uncoated pellets 100, 150. The results of these tests are direct indicators of the improved (shortened) run-up times expected with the coated pellets 200, 250 in actual fluorescent lamps. Typical placement of amalgam particle in a fluorescent lamp is shown in FIG. 5.

### EXAMPLE 2

A CuₓHg_{y} powder, where the ratio of x to y is approximately unity (1), was prepared by co-reduction of an aqueous solution containing Hg(II) and Cu(II). This material was then coated onto Zn—Hg pellets 100, 150 in a fashion identical to that described for the Ag₂Hg₃ material described above in Example 1 to create pellets 200, 250 having intermetallic coatings 205. Significantly higher mercury release rates were observed in coated pellets 200, 250 when compared to the uncoated pellets 100, 150. The results of these tests are direct indicators of the improved (shortened) run-up times expected with the coated pellets 200, 250 in actual fluorescent lamps. Typical placement of a coated pellet 200, 250 in a fluorescent lamp is shown in FIG. 5.

The present disclosure thus offers advantages over the prior art. The disclosed materials, compounds, systems, and methods provide improved mercury release rates, resulting in more rapid achievement of a desired (equilibrium) mercury vapor and therefore a lower run-up time.

While this specification contains many specifics, these should not be construed as limitations on the scope of any invention or of what may be claimed, but rather as descriptions of features that may be specific to particular embodiments of particular inventions. Figures included with this specification and discussed herein are not to scale. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What is claimed is:

1. A pellet comprising a core and a coating on at least a portion of the surface of said core, the coating being formed from a powder of one or more intermetallic compounds comprising mercury.

2. The pellet of claim 1 wherein said coating encapsulates said core.

3. The pellet of claim 1 wherein said powder comprises silver and mercury.

4. The pellet of claim 3 wherein the said powder comprises more than one form of mercury, silver and mercury-silver compounds simultaneously.

5. The pellet of claim 3 wherein said powder comprises a silver and mercury compound in the form of Ag₂Hg₃.

6. The pellet of claim 5 wherein said powder further comprises liquid mercury or a saturated amalgam in the form of a liquid silver amalgam.

7. The pellet of claim 5 wherein said powder further comprises pure silver or a silver-mercury solid solution.

8. The pellet of claim 5 wherein said powder further comprises β-AgHg intermetallic compound.

9. The pellet of claim 5 wherein said powder further comprises α-AgHg solid solution.

10. The pellet of claim 5 wherein said powder further comprises any other form of mercury and any other form of silver within the silver mercury binary system.

11. The pellet of claim 5 wherein said powder further comprises one or more metals from the group consisting of copper, tin, zinc, gold, platinum, palladium, nickel, manganese, and titanium.

12. The pellet of claim 1 wherein said powder comprises copper and mercury.

13. The pellet of claim 12 wherein the said powder comprises more than one form of mercury, copper and mercury-copper compounds simultaneously.

14. The pellet of claim 12 wherein said powder comprises a copper and mercury compound in the form of Cu₇Hg₆.

15. The pellet of claim 14 wherein said powder further comprises liquid mercury or a saturated amalgam in the form of a liquid copper amalgam.

16. The pellet of claim 14 wherein said powder further comprises pure copper or a copper-mercury solid solution.

17. The pellet of claim 14 wherein said powder further comprises α-Cu(Hg) solid solution.

18. The pellet of claim 14 wherein said powder further comprises any other form of mercury and any other form of copper within the copper mercury binary system.

19. The pellet of claim 14 wherein said powder further comprises one or more metals from the group consisting of silver, tin, zinc, gold, platinum, palladium, nickel, manganese, and titanium.

20. The pellet of claim 1 wherein said powder comprises nickel and mercury.

21. The pellet of claim 20 wherein said powder comprises a nickel and mercury compound in the form of NiHg₄.

22. The pellet of claim 1 wherein said powder comprises platinum and mercury.

23. The pellet of claim 22 wherein said powder comprises a platinum and mercury compound in the form of PtHg₂ or PtHg₄.

24. The pellet of claim 1 wherein said powder comprises palladium and mercury.

25. The pellet of claim 1 wherein said powder comprises gold and mercury.

26. The pellet of claim 1 wherein the particle size of said powder is <100 μm.

27. The pellet of claim 26 wherein the particle size of said powder is <50 μm.

28. The pellet of claim 27 wherein the particle size of said powder is <10 μm.

29. The pellet of claim 28 wherein the particle size of said powder is <1.0 μm.

30. The pellet of claim 29 wherein the particle size of said powder is <0.01 μm.

31. The pellet of claim 1 wherein said coating is formed from two or more binary intermetallic powders comprising mercury.

32. The pellet of claim 31 wherein said binary intermetallic powders comprise mercury and a metal selected from the group consisting of silver, copper, tin, zinc, gold, platinum, palladium, nickel, manganese, and titanium.

33. The pellet of claim 32 wherein said binary intermetallic powders comprise mercury and a metal selected from the group consisting of silver, copper, gold, platinum, palladium, and nickel.

34. The pellet of claim 33 wherein said binary intermetallic powders comprise mercury and a metal selected from the group consisting of silver and copper.

35. The pellet of claim 1 wherein said coating comprises between 0.1 and 20 weight percent of the pellet.

36. The pellet of claim 1 wherein the coating comprises at least five weight percent mercury.

37. The pellet of claim 36 wherein the coating comprises at least sixty weight percent mercury.

38. The pellet of claim 1 wherein said coating is formed from one or more ternary intermetallic powders comprising mercury.

39. The pellet of claim 1 wherein said powder comprises silver solid solution, saturated liquid mercury amalgam and intermetallic compounds of silver and mercury.

40. The pellet of claim 1 wherein said powder comprises copper solid solution, saturated liquid mercury amalgam and intermetallic compounds of copper and mercury.

41. The pellet of claim 1 wherein said powder comprises nickel solid solution, saturated liquid mercury amalgam and intermetallic compounds of nickel and mercury.

42. A pellet comprising a core and a coating on at least a portion of the surface of the core, said coating comprising one or more intermetallic compounds of mercury and a metal selected from the group consisting of silver, copper, tin, zinc, gold, platinum, palladium, nickel, manganese, and titanium.

43. The pellet of claim 42 wherein said core comprises an amalgam.

44. The pellet of claim 43 wherein said core comprises an amalgam formed by rapid quenching of a molten material.

45. The pellet of claim 43 wherein said core comprises an amalgam formed by mechanically plating material on a substrate.

46. The pellet of claim 43 wherein said core comprises zinc amalgam or tin amalgam.

47. The pellet of claim 43 wherein said core comprises three or more amalgam forming metals.

48. The pellet of claim 43 wherein said core comprises bismuth and two or more amalgam forming metals.

49. The pellet of claim 42 wherein said coating comprises at least five weight percent mercury.

50. The pellet of claim 49 wherein said coating comprises at least sixty weight percent mercury.

51. A pellet comprising a core and a coating on at least a portion of the surface of the core, said coating being formed from a material comprising at least five weight percent mercury.

52. The pellet of claim 51 wherein said coating is formed from a material comprising at least sixty weight percent mercury.

53. The pellet of claim 52 wherein said coating encapsulates said core.

54. The pellet of claim 51 wherein said coating encapsulates said core.

55. A pellet comprising:
a core; and
a coating encapsulating said core, said coating comprising one or more intermetallic compounds of mercury and a metal selected from the group consisting of silver, copper, tin, zinc, gold, platinum, palladium, nickel, manganese, and titanium.

56. The pellet of claim 55 wherein said coating is formed by one or more intermetallic compound powders.

57. The pellet of claim 55 wherein said core comprises an amalgam.

58. A method comprising:
providing a core; and
forming a coating on at least a portion of the surface of said core with a material comprising one or more intermetallic compounds comprising mercury and a metal selected from the group consisting of silver, copper, tin, zinc, gold, platinum, palladium, nickel, manganese, and titanium.

59. The method of claim 58 wherein the step of forming a coating comprises mechanically plating an intermetallic compound powder on at least a portion of the surface of the core.

60. A method of forming a pellet comprising:
providing a core;
encapsulating the core in a coating comprising one or more intermetallic compounds comprising mercury and a metal selected from the group consisting of silver, copper, tin, zinc, gold, platinum, palladium, nickel, manganese, and titanium.
